(19) United States
(12) Patent Application Publication
(10) Pub. No.: US 2013/0108025 A1
(43) Pub. Date: May 2, 2013

(54) Optical exit slit

(71) Applicants: Alex K. Deyhim, Ithaca, NY (US); Eric C. Van Every, Lansing, NY (US)

(72) Inventors: Alex K. Deyhim, Ithaca, NY (US); Eric C. Van Every, Lansing, NY (US)

(21) Appl. No.: 13/317,766

(22) Filed: Oct. 27, 2011

(51) Int. Cl. G21K 1/00

(52) U.S. Cl. 378/146

(57) ABSTRACT

The following precise optical slit design was analyzed in order to optimize the actuator loads, flexure stresses and heat transfer characteristics. It was shown, that monolithic flexure (made out of GlidCop) with out of vacuum water cooling piping shows adequate performance. Even for a minimal flow conditions (1.0 gal/min without spring inserts), the maximum temperature of the flexure does not exceed 90° C. for 60 W deposited power and following the same design principles 150 W power load is visible, as a Von Mises thermal stress does not exceed even half of a fatigue strength for GlidCop. Steady state thermal loads reduce the blade clearance by 50 μm (total) at the worst case scenario, but such load does not lead to blade clash, and maximum angular deviation of the slit blades at full stroke is less than 16 μrad per blade, well within the +/−2 mrad requirement.

### CROSS REFERENCE TO RELATED APPLICATIONS

Not applicable

### STATEMENT REGARDING FEDERALLY SPONSORED RESEARCH OR DEVELOPMENT

Not Applicable

### SEQUENCE LISTING OR PROGRAM

Not Applicable

### BACKGROUND OF THE INVENTION

Synchrotron Radiation (SR) instrumentation poses a special challenge and pushes the envelope for mechanical design of its components. High peak power density of 100 kW/mrad², high angular collimation (100 μrad) and small source size (˜50 μm), grazing angle geometry and extended arm length (˜10 m) are common to third generation SR sources and create design challenges comparable only to powerful lasers, (Proceedings of MEDSI 2002 conference, Sep. 5-6, 2002, Argonne National Lab, Argonne, Ill., USA). UHV requirements, remote control and sometimes a radiation harsh environment certainly do not simplify such a task.

Soft x-ray beamlines (50-2500 eV) typically have a pre-focusing optical stage, and such mirrors work well as a filter and reduce the power load to downstream components. Monochromatization is performed by grating at grazing incidence, and requires slits for spatial separation of “unwanted radiation”. Entrance/exit directions are fixed and allow the slits to be mounted on a stable platform (K. Kaznacheyev, CLS#6.2.76.4 SM project: Power load and tolerances for optical components; K. Kaznacheyev, I. Blomqvist, E. Hallin, S. Urquhart, D. Loken, T. Tyliszczak, T. Warwick, A. P. Hitchcock; Principles of optical design of the SM beamline at the CLS, proceedings of SRI2003 conference, ed. T. Warwick, AIP 2004). Power density is still kept very high (especially at focusing points) and limits the choice of materials. Precise, backlash free mechanical design with submicron accuracy is required and often calls for a direct reading of blade position.

In addition, blades need to be electrically insulated (to provide a beam monitoring) and placed in a UHV bakeable vessel with out-of-vacuum actuation. Fortunately, tungsten's soft x-ray attenuation coefficient does not exceed 0.4 μm even at high energy, which means that even a thin blade is opaque to soft x-rays and there is no radiation hazard as with hard x-ray applications (K. Kaznacheyev, CLS#6.2.76.15, ID10 chicane magnet layout and the SM performance in quick polarization exchange mode; Petukhov and Hartnett, Advances in Heat Transfer, vol. 6, Academic Press, NY, 1970). Such requirements are quite common and this makes us believe that there is need for a generic design of precise optical slits for soft x-ray beamlines.

### SUMMARY OF THE INVENTION

UHV version of flexure based, precise optical slit, compatible with requirement s of modern soft x-ray SR beamlines, has been designed by ADC. The following article describes requirements, design principles and mechanical performance of a slit on a basis of an extended thermal and structural FEA analysis.

### BRIEF DESCRIPTION OF DRAWINGS

The invention as described herein with references to subsequent drawings, contains similar reference characters intended to designate like elements throughout the depictions and several views of the depictions. It is understood that in some cases, various aspects and views of the invention may be exaggerated or blown up (enlarged) in order to facilitate a common understanding of the invention and its associated parts.

FIG. 1 shows the mechanical model of the slit flexure.

FIG. 2 is a schematic drawing of the chamber enclosing the exit slit.

FIG. 3 shows one of the precise actuators.

FIG. 4 shows the chamber cross section with monolithic flexure.

FIG. 5 shows the chamber cross section with cooling passages.

FIG. 6 is a table of thermal properties for each material and contact resistance.

FIG. 7 is a table of the water properties, flow conditions and convection coefficients

FIG. 8 is a plot of Maximum Equivalent Stress in Flexure Web vs Actuator Motion.

FIG. 9 is a plot of Actuator Load vs Motion.

FIG. 10 is a plot of Slit Blade Opening vs Actuator Motion.

FIG. 11 is a plot of Slit Blade Angle vs Actuator Motion.

FIG. 12 is a table of temperature distribution range in monolithic flexure and vacuum chamber for 60 W total input power.

### DETAILED DESCRIPTION OF INVENTION

Provided herein is a detailed description of one embodiment of the invention. It is to be understood, however, that the present invention may be embodied with various dimensions. Therefore, specific details enclosed herein are not to be interpreted as limiting, but rather as a basis for the claims and as a representative basis for teaching one skilled in the art to employ the present invention in virtually any appropriately detailed system, structure, or manner.

SM beamline has no entrance slit, but an exit slit on each of the SM branches: Photo Electron Emission Microscope (PEEM) and Scanning Transmission X-ray Microscope (STXM). These exit slits need to be water cooled, as the maximum power load at zero order is ˜60 W. The exit slits have dual purpose: first to determine the energy window that is delivered to each experiment; second, to serve as the source point for optics which perform further demagnification. Because both the elliptical refocusing mirror of PEEM branch and Zone Plate for STXM branch are stigmatic optics, the displacement along the beam between the vertical and horizontal blade pair shall not exceed the depth of focus of the two downstream optics (5 mm).

The STXM phase acceptance (numerical aperture*exit slit size width) for ultimate spatial resolution should not exceed λ (photon wavelength), and so for a 200 μm diameter Zone Plate at 3 m from the exit slit and 2000 eV photon beam, the exit slit opening will be as small as 6 μm. For the PEEM branch, the e⁻-source projection to the exit slit will result in a spot size ˜150(h)*7(v) (to 15 depending on grating setting) microns. The nominal resolving power of 3000 this corresponds to slit sizes of 70-20(v) microns, depending on energy and grating settings. A total 0.5 mm total slit opening is required. For the SM beamline, the nominal along-the-beam location of the exit slit does not depend upon the energy and grating setting, but to facilitate the beamline alignment, the exit slit will be placed on an X-Y linear slide and should have a flat bottom.

All beamline components are UHV compatible (˜10⁻¹⁰ torr) and can withstand bake-out to 150° C. for 48 hours, and retain performance characteristics upon cooling to room temperature.

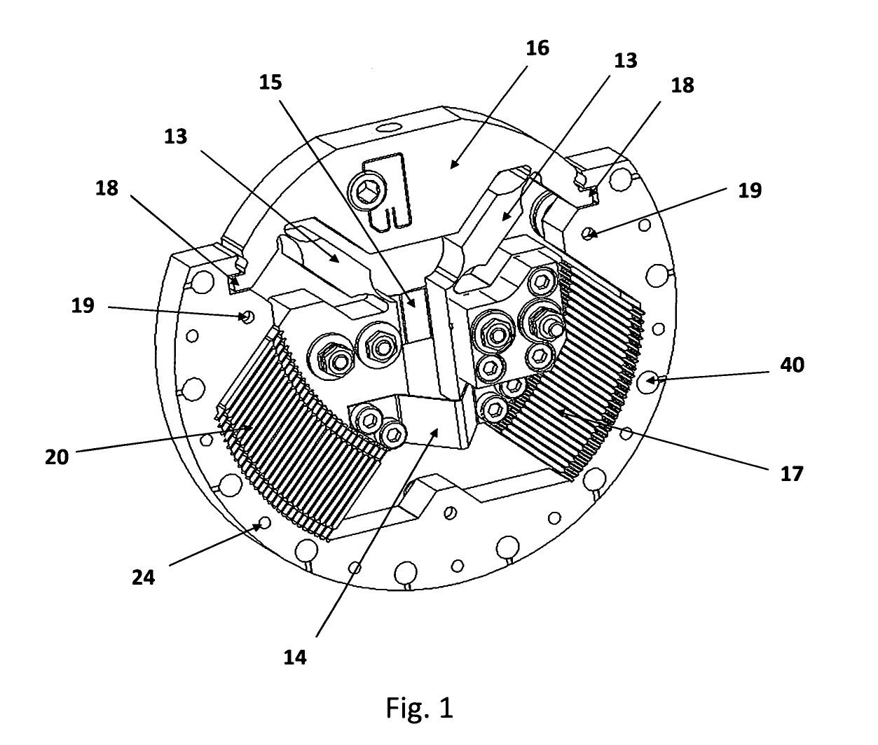

Because of the small range of blade movement and required accuracy of travel, a monolithic flexure 16 design is used, seen in FIG. 1. Two parallelogram linkages 13 with an out-of-plane bridge 14 provide a simple design for parallel movement of the slit blades 15. The out of plane flexure is provided to enforce blade opening symmetry. The 45 degree angle of flexures 17 produces a one-to-one ratio between actuator movement and change in the slit opening. This relationship minimizes the bending angle required of the flexures. The end of travel stops 18 are built into the monolith and restrict the actuation movement to +/−0.34 mm. Dowel pin holes 19 near the over-travel stops 18 are provided to define the initial geometry of the flexure bolt-up ring because it tends to spring open when completion of machining frees up internal material stresses. The flexure is attached to a holding fixture during adjustment and is not detached until after it has been secured in its final place in the vacuum chamber. The pins also serve to lock up the flexure and protect it from overstress during adjustment and actuator attachment. The tungsten blades are fabricated from 1 mm thick rectangular plate with edges polished at 20 degrees for clearance, and the final 15 μm of edge is 45 degrees.

During assembly alignment, milling machine fixture clamps featuring off centric mounting bolts are used to hold the fine adjustments while the mount block is secured. The blades will have been pre aligned to better that 2 mrad parallel accuracy during installation. A small offset (50 μm) allows a complete close of the blades with small overlapping along beam direction. A 1 mm thickness of ceramic provides electrical resistance between the blade and grounded flexure. This is still thin enough for sufficient thermal conductivity from blade to flexure.

To provide sufficient heat conductance an array of parallel flexure elements 20 are used to connect the slit flexure to the main body. For a given thickness of the monolith, thermal conductivity is proportional to the thickness of the linkage throat, but so is material stress, and force required scales as the cube. Several small linkages are a viable means of providing sufficient cross sectional area for conduction. Balancing requirements for conduction, stress, actuation force, and fabrication costs, we have limited the number of heat-conducting flexure elements to 24 per blade and the thickness of 0.25 μm. The actuation flexure is made thicker, (0.3 μm) and includes a longer throat because of higher stresses and no thermal conduction requirement.

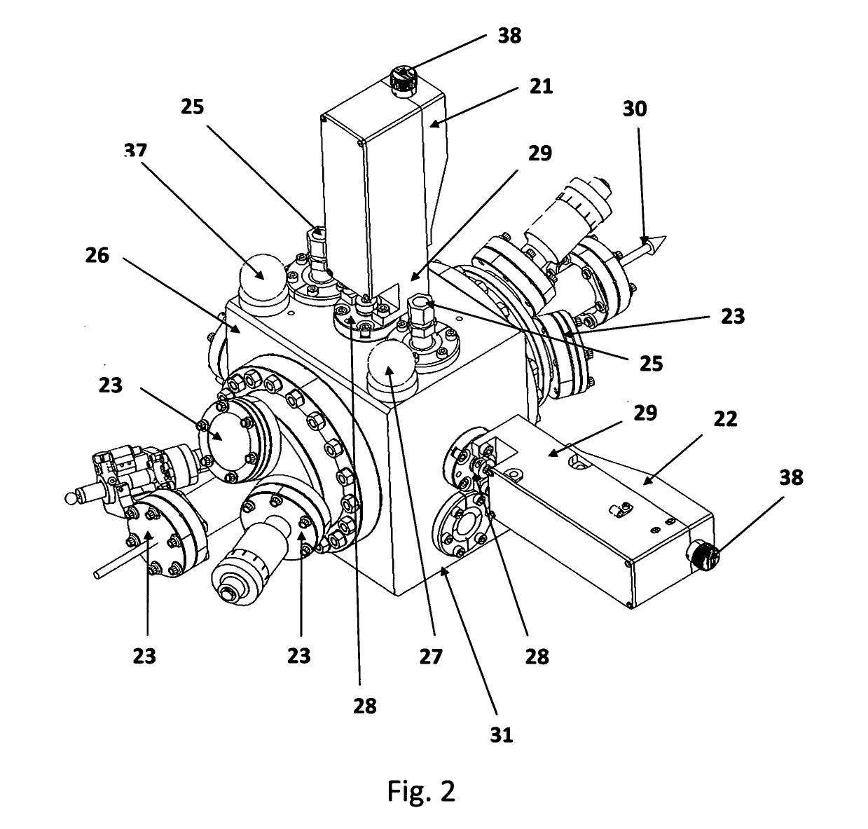

The vertical slit 21, can be seen in FIG. 2, (with horizontally aligned blade edges) is a 90 degree copy of the horizontal slit 22 and placed further downstream. Both flexure monoliths 16 are attached to a flange 23 within the 304 stainless steel (SS) body by ten #6 screws, in screw holes 24, for efficient thermal contact with the water cooled chamber; larger mounting holes are also present 40. Water channels 25 are drilled directly into the SS chamber 26 with no water to air joints. An additional electrode is placed between the two slits (horizontal 22 and vertical 21), so one can bias it to positive voltage (up to 1 kV) to get an accurate electron yield measurement from the blades 15. The slit vessel has precisely located holes for 3 ball mounted hollow retro-reflectors 27 used in laser alignment to the beamline. Upstream and downstream flanges (6¾″OD CF) are multi-flange assemblies having provision for smaller conflate (CF) flanges 23. Two are used for rotary feed-throughs 28. A YAG crystal can be inserted before the slit for visualization of beam direction 30. A Si diode inserted downstream can provide an absolute measure for photon flux. A laser port points at the slit opening and a viewport opposite allows for independent verification of slit opening calibration by diffraction measurements.

The overall dimensions of the Slit Unit are: upstream to downstream flanges (2¾″ OD CF) is 460 mm, but a more compact design is possible. Slit actuation 29 is made to protrude up and to the right as seen along the beam and cooling water enters from left and exits up. The main slit cube is 194 mm wide×200 mm high×150 mm parallel to the beam and has a flat bottom with tapped holes 31 for mounting on a linear stage. The overall weight is approximately 40 kg.

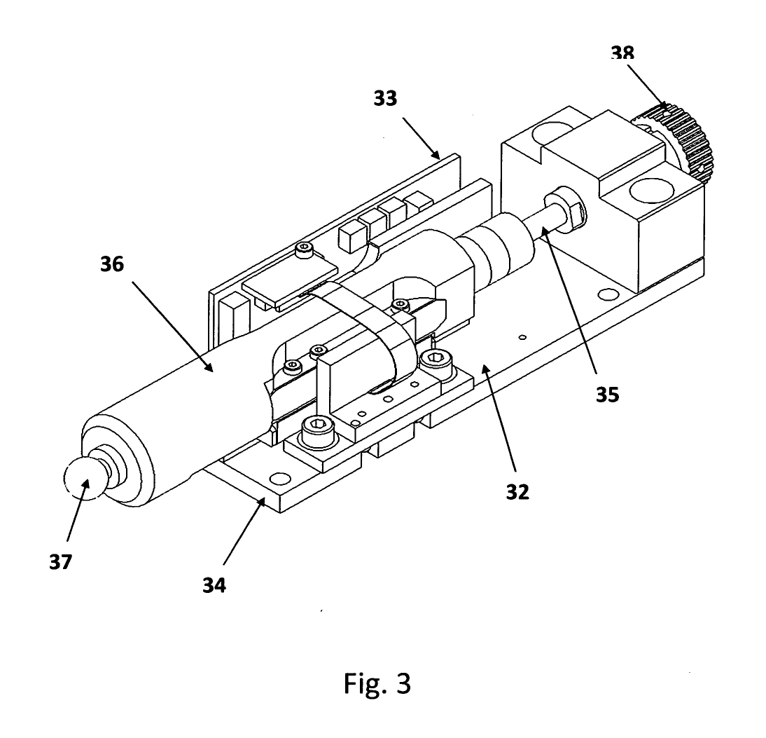

Available actuators for the slit unit were not found to meet all requirements for this application and so a new actuator design was produced, FIG. 3. The primary improvements of the new actuator 32 design called for higher thrust capacity (120 N) and a much stiffer housing 33 with mounting 34 on a plane perpendicular to actuation. Since the actuators will be removed during bake-out, it is desired to remount them without a need to recalibrate the slit opening. To achieve this goal, the flexures are spring biased to fully open when not actuated. The bias spring also overcomes the vacuum load. This means no physical connection needs to be reattached between the actuator and the feed through to the flexure after bakeout since the actuator pushes only. (The option to pull with this actuator is in the design and pulling has the same design specifications as pushing. However, the tapered locking connector to pull adds a variable if disconnected and reattached.)

This high performance, linear actuator features a precision preloaded ball screw 35, mounted concentric with the non-rotating output and perpendicular to the mounting surface of its rugged housing 33. This configuration makes it equally adept at push-only or push-pull type applications at significantly higher loads than competitive offerings. There are of no reflected loads to the preloaded linear slide that provides guidance. Therefore the accuracy potential of its micro-stepping motor and high precision linear encoder are met throughout its loading envelope. Optical switches (internal) 36 indicate travel limits and zero position. A non-traversing tapered connection attaches to your shaft for pull-push mode, or a steel tooling ball 37 is mounted for push-only mode. A manual knob 38 allows sensitive touch-off zero confirmation in push mode applications.

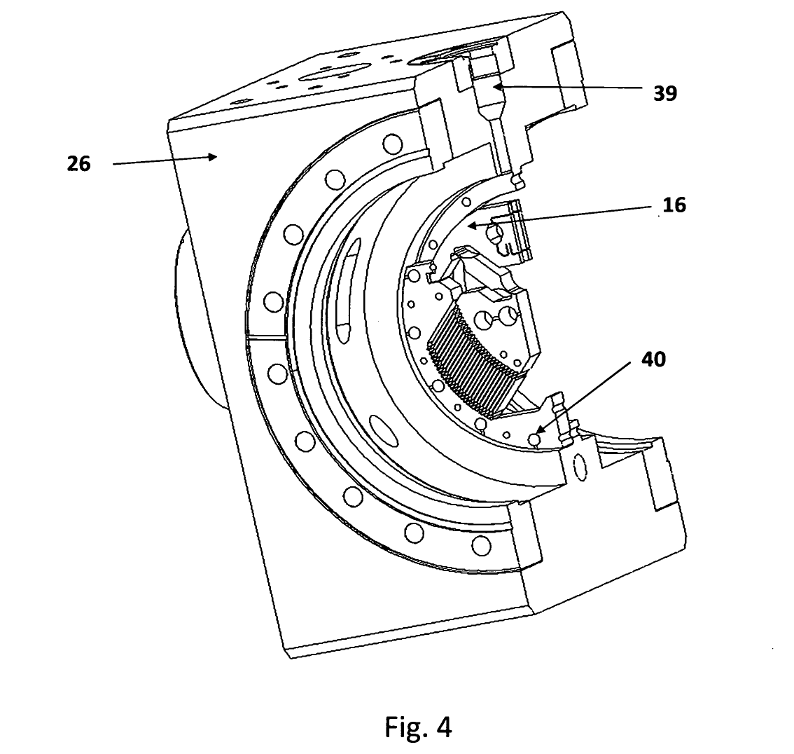

A number of designs were analyzed in order to optimize actuator loads, flexure stresses, and heat transfer characteristics of the monolithic flexure assembly 16. This design optimization of the monolithic flexure included material selection, several geometric aspects and cooling passage 39 placement within the chamber 26. A graphic representation of the subject design can be seen in FIG. 4. Multiple cooling water flow conditions were evaluated for their effect on the heat transfer aspects of the monolithic flexure design. Of primary concern was the thermally induced stress and deformation of the flexure and its effects on, 1) the slit blade clearance in the closed position and 2) the angular deviation of the slit blades. The following analysis shows slit performance.

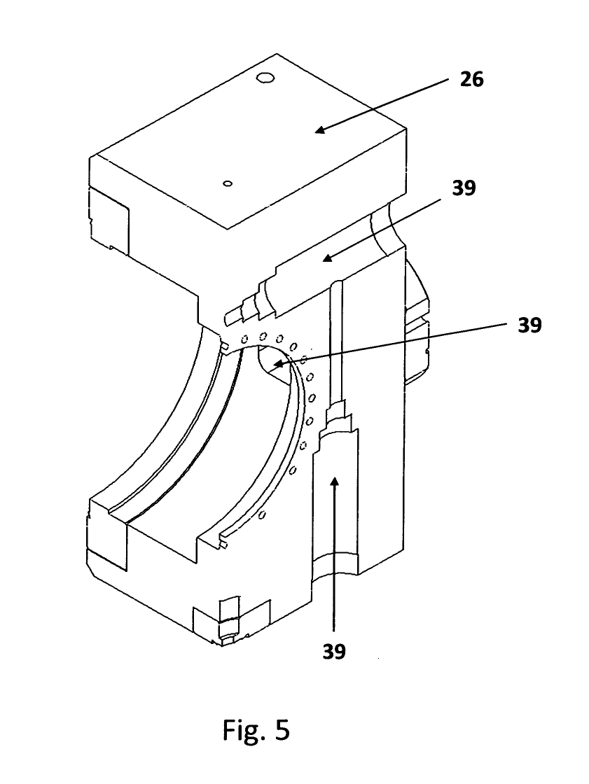

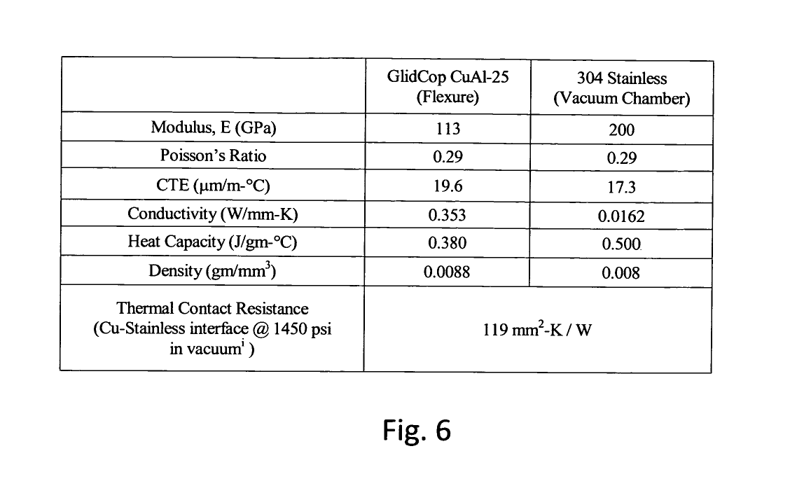

Cooling of the monolithic flexure is accomplished via conduction through the GlidCop flexure structure and the 304 SS vacuum chamber 26 with subsequent convection to the water flow within the cooling passages 39 in the vacuum chamber, FIG. 5. Convection from the external surfaces of the vacuum chamber has been conservatively neglected. The relevant parameters associated with cooling are the thermal properties of the materials involved, the thermal contact resistance at various bolted interfaces and the convective properties afforded by the water flow. Thermal properties for each material and contact resistance values are listed in FIG. 6. Note that the thermal contact resistance assumed between the GlidCop flexure and the stainless vacuum chamber is a conservative estimate based on a fairly low contact pressure.

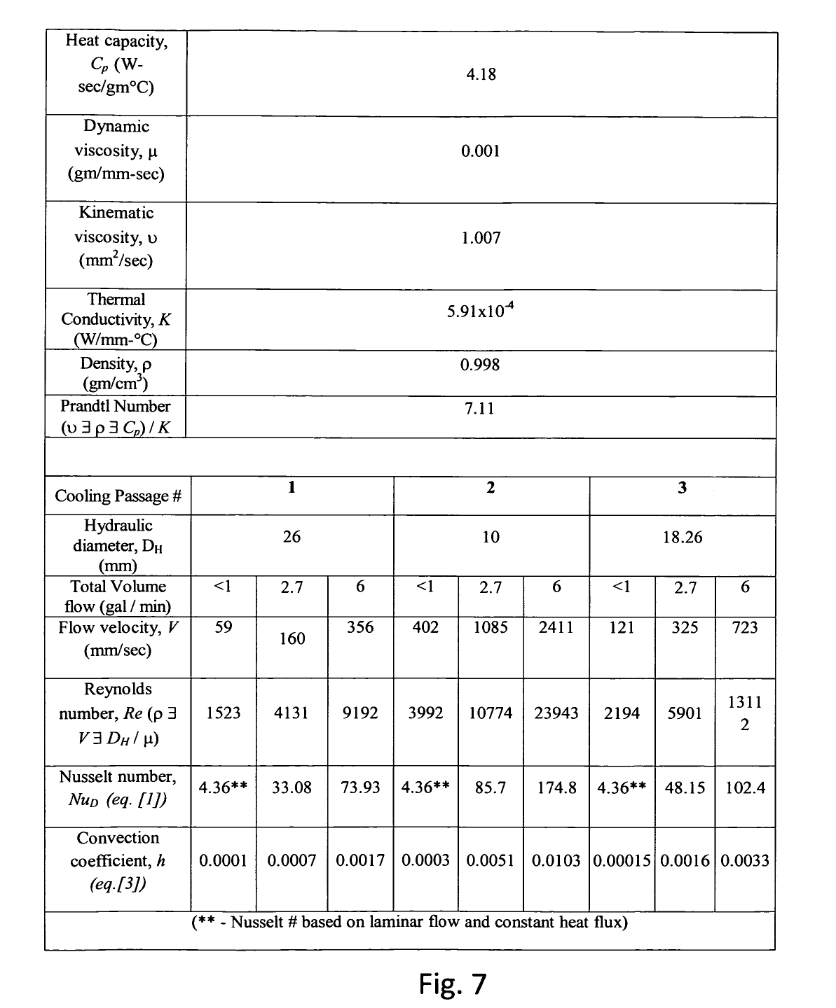

In order to calculate the convective heat transfer coefficient(s) associated with the water flow in the cooling passages, several flow conditions were assumed ranging from laminar to potentially turbulent flow. The water properties, flow conditions and convection coefficients are listed in FIG. 7. Note that for Reynolds numbers above ˜3000, the following convection correlation for transition and turbulent flow is used:

$${Nu}_{D} = \frac{( f \text{/} 8 ) ( {Re}_{D} - 1000 ) Pr}{1 + 12.7 {( f \text{/} 8 )}^{1 / 2} ( {Pr}^{2 / 3} - 1 )} \qquad ( 1 )$$

where: f=(0.790 ln Re_{D}−1.64)⁻². (2)

The convection coefficient is defined as

h=kNu_{D}/D_{H}. (3)

Re_{D} and Pr are defined in FIG. 7. These correlations have been shown to be valid for 0.5<Pr<2000 and 3000<Re_{D}<5×10⁶. Also, it is further assumed that water properties do not vary between 20° C. and 25° C. enough to have a significant effect on the analysis results. For flow rates of 1 gal/min or less, laminar flow is assumed in each passage based on the calculated Reynolds numbers, i.e., <2000. This assumption was also made for cooling passage #2 since its length is too short for turbulent flow to fully develop even though its Reynolds number exceeds 2000. The asymptotic Nusselt number associated with fully developed laminar flow and constant heat flux was used to calculate the corresponding convective heat transfer coefficient. Note that the total volume flow rates listed in FIG. 7 are assumed to be evenly distributed between the 2 basic cooling paths.

ANSYS 8.0® was used for all finite element simulations. Higher order quadratic elements were employed for each phase of the analysis. For a given level of mesh discretization, quadratic elements typically yield higher accuracy of results when compared to linear elements. Additionally, curved boundaries can be modeled precisely with higher order elements and tetrahedral elements may be used where topographically required without compromising solution accuracy.

Owing to the 2-D nature of the flexure, a plane strain model was utilized for the structural analysis. Approximately 10,250 elements and 33,700 nodes comprised the model. Mesh density in the thin areas of the monolithic flexure was optimized to insure convergence of stress results in these areas as they are subjected to the greatest amount of bending stress by design; ½ symmetry was assumed for the structure. Appropriate displacement boundary conditions (Ux=0) were applied to the vertical symmetry edges on the left side of the model. Full displacement restraints were applied at the mounting holes 40 on the outer periphery of the flexure (5 larger holes). Applied loads consisted of displacements, corresponding to the limits of actuator travel (+/−0.34 mm), and were applied to the lower left vertical edge along with the symmetry condition previously imposed. Linear elastic material properties were assumed for the GlidCop, FIG. 6. The structural simulation included the effects of geometric nonlinearity, also referred to as large displacement theory. This was done in order to evaluate the linearity, or lack thereof; of the flexure throughout the full range of actuation, and account for potential relatively large angular motions of the structural elements (individual flexures).

The 3D nature of the steady state heat transfer analysis required a corresponding three dimensional finite element model, see FIG. 4. The 2D mesh of the structural model was used as the basis for this 3D model. This would later facilitate the transfer of temperature distribution results for the thermomechanical simulation. All elements within the flexure were hexahedral as they were extruded from the original quadrilateral mesh of the structural model. Surface-to-surface contact elements were utilized between the flexure and the vacuum chamber so as to account for the thermal contact resistance at this bolted interface. A rather conservative estimate of the contact resistance has been employed based on limited available data and the low contact pressure assumed, FIG. 6. The finite element model included 149,390 elements and 562,021 nodes; ½ symmetry was again employed for the thermal analysis. Only the upstream flexure was included in the thermal model on the assumption that the vast majority of the power from the incident radiation would be absorbed by this component. On the symmetry plane the heat flux was specified as zero. Corresponding to the slit blade location, is where the 30 watts (per side) of input power is applied.

Three flow regimes were evaluated for their cooling effectiveness. Although not shown in the figure, convective heat transfer coefficients were specified on the inner walls of the cooling passages as listed in FIG. 7. The total volume flow rates listed in Table 2 are assumed to be evenly distributed between the 2 basic cooling paths, as this will be adjusted with flow control valves. Convective heat transfer coefficients were based on Reynolds numbers corresponding to laminar, transitional and turbulent flow conditions. The use of chilled water (20° C.) was assumed for the simulation(s). No free convection was specified for external surfaces and radiation was neglected.

Because of the considerable computational resources required (memory in particular) to solve the thermomechanical problem using the 3D flexure model, the 2D model from the structural analysis was utilized for this simulation. The temperature distribution on the center-plane of the 3D thermal model, corresponding to minimal flow conditions, was superimposed on the 2D structural model. This is a reasonable approximation since the temperature variation through the thickness of the flexure was not seen to be significant, less than 1-2° C. The thermomechanical simulation was completely linear in nature, both from a geometric and material perspective.

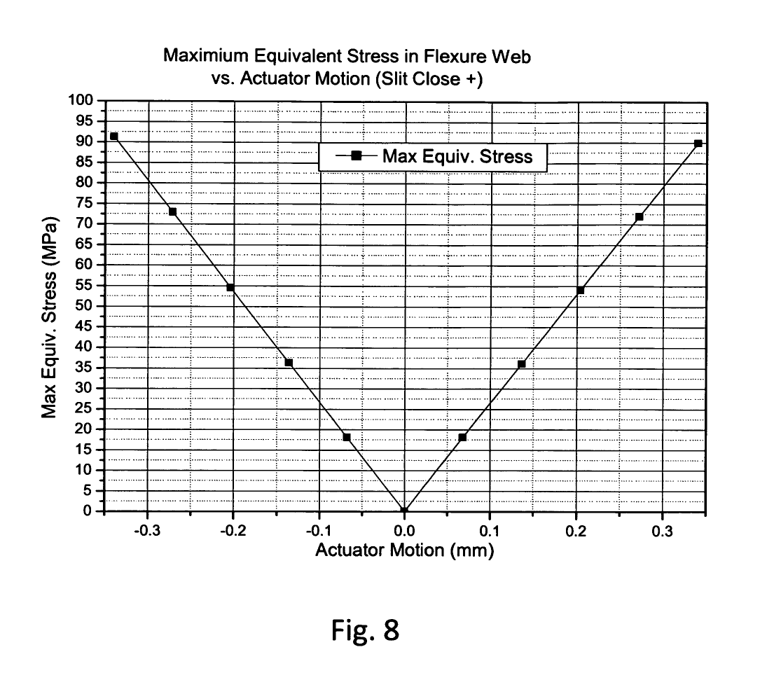

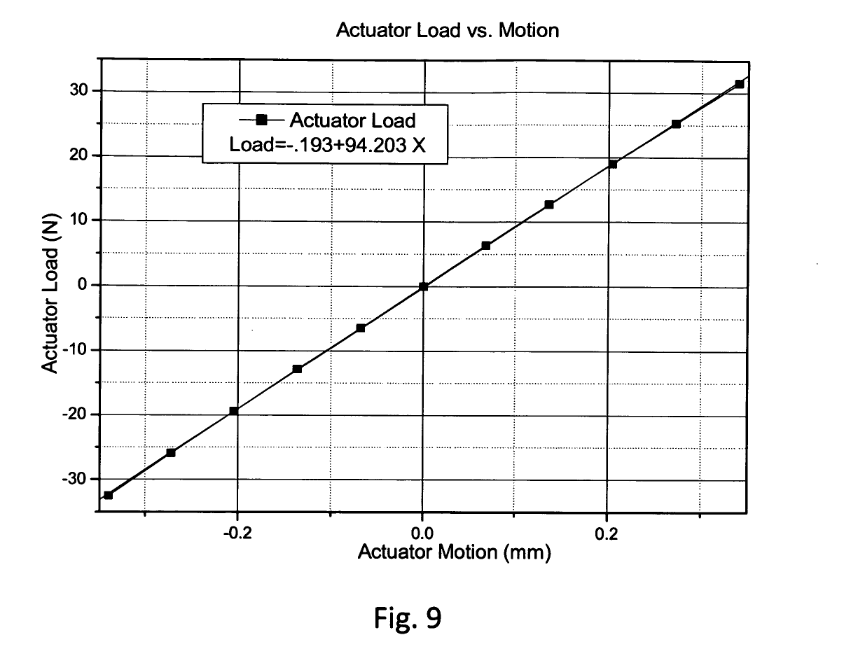

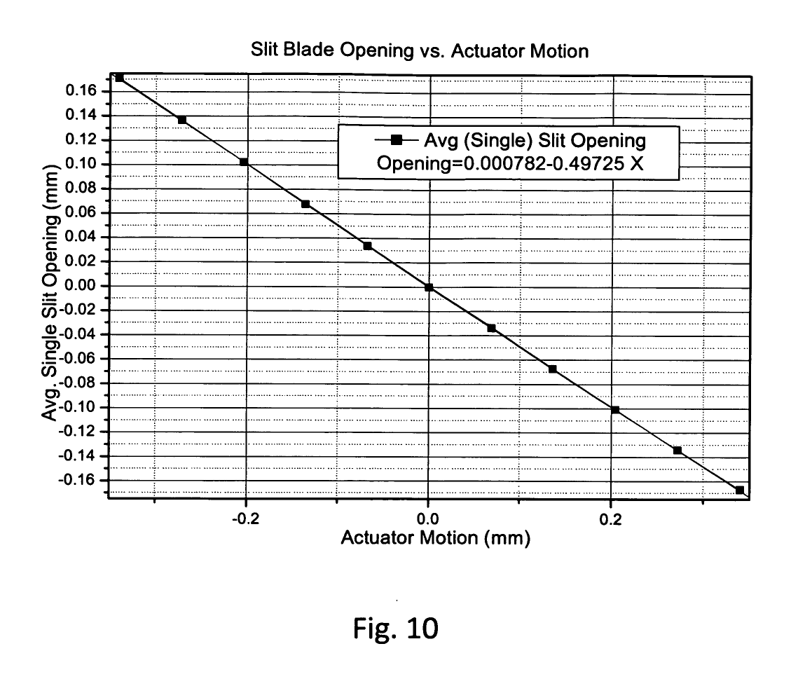

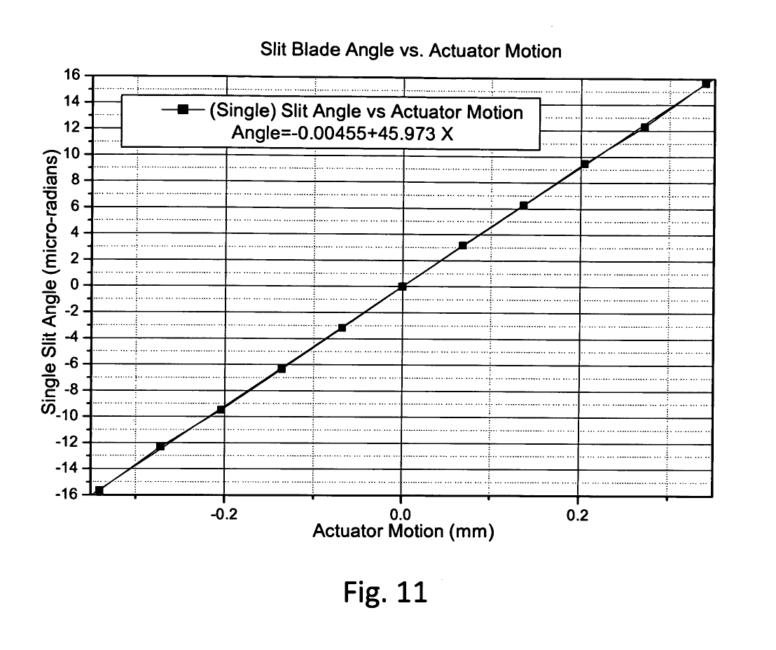

A graph of the maximum equivalent stress vs. actuator motion can be seen in FIG. 8. The stress in the monolithic flexure is concentrated in the webs of each individual flexure as these are the locations of maximum bending. Stress calculated for the flexure at the full stroke of −0.34 mm (slit blades full open) is 91.3 MPa. The fatigue strength of GlidCop CuAl25 (C15720) has been reported in the literature (see ref 2, 3) to be ˜190 MPa@10⁶ cycles for fully reversed bending. This translates to a factor of safety of greater than 2 with respect to the monolithic flexure stress and its fatigue performance in the current application. Anticipated usage is 1.3×10⁵ cycles over 15 years. As seen in FIG. 8 through 11, the response of the monolithic flexure to actuator inputs is basically linear. Variations of less than 3% exist at the actuation extremes in the equivalent stress (FIG. 8), actuator load (FIG. 9), and slit blade opening (FIG. 10). One potential source for this slight nonlinearity is the directional aspects of the axial loads induced in the individual flexures. While the main flexure is in a state of axial compression, superimposed over the bending stresses, each minor flexure experiences a tensile axial load superimposed over bending stresses. This situation is reversed when the actuator is driven in the opposite direction, i.e., slit blade opening. FIG. 9 shows the actuator load vs. motion response of the monolithic flexure. The maximum load is exhibited in the full open position of the slit blades and is 32.5 N. This load corresponds to 27% of the actuators maximum capability. FIG. 10 is a plot of the slit blade position as a function of the actuator motion. FIG. 11 depicts the slit blade angle as a function of actuator motion. Note that the ordinate is in μrad. The peak value of 16 μrad is well below the allowable limit of +/−2 mrad.

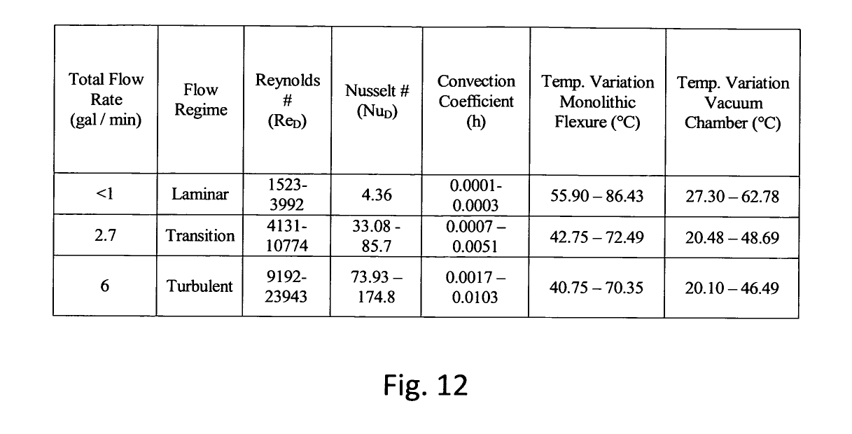

As mentioned previously, three flow rates were evaluated for their effect on the cooling of the monolithic flexure. Based on the range of estimated Reynolds numbers for each cooling passage, the flow regimes are referred to as laminar, transitional and turbulent. The results from the heat transfer analysis are summarized in FIG. 12 for each of these flow regimes. Ranges are listed for the Reynolds #, Nusselt # and convection coefficient which correspond to the variations associated with the cooling passages for each given volume flow rate. Regardless of the flow rates investigated through the cooling passages, the temperature variation throughout the monolithic flexure remains constant at about 30° C., only the range of temperature changes. Even at a minimal rate of flow, i.e., less than 1 gal/min, the maximum temperature on the flexure is calculated to be less than 87° C., 13° C. below the targeted 100° C. maximum. A 15% reduction in peak flexure temperature can be realized with a modest increase in water flow. As this provides for a significant increase in the margin of safety with respect to maximum temperature, the total flow rate is specified at 2.7 gal/min or greater through the vacuum chamber cooling passages. Helical inserts in the water passages will be used to induce turbulence at lower flow rates and conserve cooling water. However, the effect of these inserts is beyond the scope of this analysis.

At a total flow rate of 2.7 gal/min, which has been termed transitional flow, wall temperatures for the cooling passages are typically well below 26° C. validating the assumption of constant properties for the water at this volume rate of flow (and greater). For the minimal flow rate evaluated, the average wall temperature of the cooling passages was seen to be as high as 35° C. Although this is not excessive, its effect on the properties of the water could potentially increase the calculated temperature distribution within the flexure by several degrees. The thermal resistance is seen to be fairly evenly split between the flexure and the bolted interface/vacuum chamber for this flow condition.

The intent of the thermomechanical analysis is to determine the thermally induced deformation of the monolithic flexure at steady state operating conditions. This is an important aspect of the design with respect to slit blade clearance in the fully closed position and potential angular deviation. In the area of the slit blade, the maximum horizontal displacement is −27 μm. This indicates that a slit blade clearance of 54 μm would be required of the design. Further, results show that under these coolant flow conditions, the angular deviation of the slit blade will be 0.19 mrad, well below the +/−2 mrad allowed.

What is claimed is:

1. An optical exit slit for use in soft x-ray beamlines, comprising:
(a) monolithic flexures;
(b) a main slit cube chamber;
(c) a vertical slit with actuator;
(d) a horizontal slit with actuator;
(e) cooling chambers.

2. The apparatus of claim 1 wherein said monolithic flexure design is favored due to the small range of blade movement and required accuracy of travel.

3. The apparatus of claim 2 wherein said monolithic flexure comprises:
(f) parallelogram linkages;
(g) out of plane bridge;
(h) end of travel stops;
(i) parallel flexure elements;
(j) slit blades.

4. The apparatus of claim 3 wherein two parallelogram linkages with an out-of-plane bridge provide a simple design for parallel movement of the slit blades.

5. The apparatus of claim 3 wherein the 45 degree angle of flexures produces a one-to-one ratio between actuator movement and change in the slit opening, minimizing the bending angle required of the flexures.

6. The apparatus of claim 3 wherein said parallel flexure elements are used to connect the slit flexure to the main body with several small linkages are a viable means of providing sufficient cross sectional area for conduction.

7. The apparatus of claim 3 wherein flexure monoliths are attached to a flange within the 304 stainless steel (SS) body by ten #6 screws for efficient thermal contact with the water cooled chamber.

8. The apparatus of claim 3 wherein the end of travel stops are built into the monolith and restrict the actuation movement.

9. The apparatus of claim 3 wherein said slit blades are fabricated from tungsten and are:
(k) formed from rectangular plates;
(l) edges polished at 20 degrees for clearance;
(m) the final 15 μm of edge is 45 degrees.

10. The apparatus of claim 1 wherein said slit cube chamber comprises said vertical slit with actuator, horizontal slit with actuator, monolithic flexures and cooling chambers.

11. The apparatus of claim 10 wherein the vertical slit is a 90 degree rotated copy of the horizontal slit.

12. The apparatus of claim 11 wherein an additional electrode is placed between the two slits (horizontal and vertical), so one can bias it to positive voltage (up to 1 kV) to get an accurate electron yield measurement from the blades.

13. The apparatus of claim 10 wherein the actuators, mechanical devices used to move a mechanism, with higher thrust capacity and stiffer housing and mounting plate than actuators already available.

14. The apparatus of claim 13 wherein the thrust capacity is 120 N.

15. The apparatus of claim 13 wherein said actuators feature a precision preloaded ball screw mounted concentric with the non-rotating output and perpendicular to the mounting surface.

16. The apparatus of claim 13 wherein actuator configuration comprises a steel tooling ball for push mode, but can be replaced with a non-traversing tapered connection for pull-push mode.

17. The apparatus of claim 13 wherein the manual knob attached opposite the steel tooling ball allows for sensitive touch-off zero confirmation in push applications.

18. The apparatus of claim 13 wherein internal optical switches indicate travel limits and zero position

19. The apparatus of claim 10 wherein said monolithic flexures are cooled via conduction with subsequent convection to the water flow within the said cooling passages.
